(19) United States
(12) Patent Application Publication
(10) Pub. No.: US 2014/0313857 A1
(43) Pub. Date: Oct. 23, 2014

(54) Acoustic propagation method

(71) Applicant: Bruce Kelley Horton, Redwood City, CA (US)

(72) Inventor: Bruce Kelley Horton, Redwood City, CA (US)

(21) Appl. No.: 10/526,609

(22) Filed: May 2, 2005

(51) Int. Cl. G01S 5/26

(52) U.S. Cl. CPC G01S 5/26
USPC 367/117

(57) ABSTRACT

Array of acoustic infrasonic transmitters are deployed around an area of target interest and continuously transmit acoustic time marked signals. An unintentional transduction of these acoustic time mark signals is made by a person of nefarious intent, and the resultant live or recorded signal is delivered to the receiver. In the case of many terrorist recordings the transduction is a handheld VTR recording of some political speech or event and the recording of that event is made available thought videotapes delivered to local media. The transduction is analyzed for acoustic time mark signals, which when processed using reverse TDOA methods provides the location of the signal transduction.

### BACKGROUND OF THE INVENTION

1. Field of the Invention

This invention relates generally to geolocation using acoustic propagation, and more particularly to infrasonic acoustic geolocation methods for determining when and where a recording was previously made or a live signal is being collected.

2. Description of the Related Art

Throughout history there have been various attempts, usually by those involved in nefarious activities, such as theft, kidnapping, blackmail, or terrorism, to send communications where authorship, authenticity, and time of transmission are easily verifiable but where the location of the origination remains hidden from the receivers. Early examples might include a photograph of a kidnapped victim holding a popular newspaper. Though not foolproof this allows the receiver of the communication to readily verify that the sender is the kidnapper himself, that the transmission is authentic in that he has the kidnap victim in his control, and that he had the kidnap victim in his control after a specific time, the publication time of that edition of the popular newspaper.

In the case of kidnapping, telephone later replaced the mailed photograph with the victim's voice providing the authentication and the nature of telephony providing verification of the instant time. All methods of these type attempt to provide what the information security community calls: authentication proof that the sender is whom he claims to be, the holder of the kidnap victim for example; data integrity verification that the data has not be modified, the victim is who the kidnapper says he is and proof that the control over the victim is taking place subsequent to a specified time; and, although not always desired by the criminal element but often desired by the political terrorist element, non-repudiation assurance that the transmitter of the data cannot later deny participation, this ensures “credit” is allocated to the proper persons.

Clearly the verification of time is not important if the surrounding information confirms the kidnapping or other act so that any recent photograph cannot be used, but is critical to show the victim is or was still alive at a particular time so as to coerce persons or governments to change behavior or make a payment as demanded.

These methods of communications carried certain risks for the sender. Landmarks in photographs can be identified. Telephone calls and packages can be traced. So, the methods of nefarious communications evolved to take advantage of new technologies as they became available.

Because of the ease of tracing the origin and location of telephone calls can be determined in the modern electronic era, and because of the greater impact, persuasiveness, flexibility in editing etc., most such nefarious communications are now audio or video recordings that are transmitted via some combination of analog of digital recordings, RF or internet transmissions, postal mail, and physical package delivery. Like historical methods, all of these methods are designed to provide to provide authentication, data integrity, and non-repudiation while obscuring the origin and location of the recording itself.

Unlike live telephonic or radio communications these post facto delivery methods can fake the authentication of the time of origination. For example, a political activist that references the outcome of a US election might make two recordings that cites a Democratic or Republican win and then release the correct tape after the election in an attempt to convince the receiver that the tape was made before the election. Often this is done to assure the followers of the activist that he or she is still alive and at-large. By carefully selecting future certain events of unknown outcome one can mislead the receivers of the message as to its time of origin for many years.

As is well known from watching any good detective show, traditional methods of identifying landmarks and background sounds might also identify the hidden location or time of origin of the recording. We've all seen the victims rescued or the bad-guy caught because of the sound of a certain subway train or drawbridge signal was inadvertently included in the ransom tape, or perhaps the image of some known landmark was seen in an unintended reflection.

But, wary individuals make efforts ensure that no discernible landmarks or overt background sounds are introduced into the recording or telephonic conversation. Terrorist and kidnapping videos and telephonic communications are typically recorded indoors now.

### SUMMARY OF THE INVENTION

In consideration of the problems detailed above and the limitations enumerated in the partial solutions thereto, an object of the present invention is to provide a method for determining the location at which a recording was made or from which an audio transmission was originally transduced from audio by analyzing infrasonic information inadvertently recorded on the media.

Another object of the present invention is to also provide the time at which a recording was made by analyzing infrasonic information.

Yet another object of the present invention is to provide time or location information about a recording through intentionally introduced infrasonics.

Yet another object of the present invention is to provide time or location information about a recording through background infrasonics.

In order to attain the objectives described above, according to an aspect of the present invention, there is provided an acoustic propagation method whereby infrasonic acoustic geolocation methods are used for determining when and where a signal was originally transduced from audio by analyzing infrasonic information.

In searching for an unknown target location, hereinafter described as where an audio signal was first originally transduced from audio to some electronic form thereof (either a recording or in the case of radio or other telephony a live electrical signal), where the electronic form of the transduced audio is available, infrasonic information intentionally or unintentionally present in the electronic form can be used to determine some parametric information about where and when the transduction took place. For example if a terrorist makes a video recording at some unknown location and at an unknown time and that recording also contains infrasonic signals generated from multiple known locations, which such signals having time correlated modulation then the location of the making of the original recording can be determined using known Time Difference of Arrival (TDOA) or Frequency Difference of Arrival (FDOA) techniques. These geolocation techniques will provide the location of the original making of the tape, and hence the location of the terrorist, even if the original recording is retransmitted, copied, or broadcast, as long as the infrasonic fidelity of the retransmission, coping, or broadcast is sufficient.

In the most common mode we are discussing a terrorist holding or executing hostages, which he videotapes, using a common off-the-shelf portable video tape recorder (VTR). Common off-the-shelf VTRs typically provide recording fidelity from infrasonics, below the frequency thresholds of most people, to ultrasonics, frequencies above human hearing. These techniques will work with any correlated modulations but infrasonic transmissions have several advantages. Infrasonic frequencies are by definition inaudible and hence do not alert the personnel making the original transduction to their presence, in effect causing the terrorist in this example to unknowingly record signals by which his geolocation and time of recording can be derived. As an analogy, a GPS receiver determines the precise time and location. A commercially available handheld video recorder could perform a similar function using audio instead of RF signals. Unfortunately, most video and audio commercial recording systems don't record any proforma information that would provide the required information but do record infrasonic frequencies well below those audible to the human ear. Some modern handheld videotape recorders may have a frequency response of less than an order of magnitude down from peak response to as low as 10 Hz.

Another advantage of infrasonic transmissions is that they have excellent propagation characteristics in both rural and urban environments and are not appreciably attenuated by common building materials, allowing these geolocation techniques to work even where the original transduction is made inside of a thick-walled building.

Infrasonics also have very low atmospheric attenuation allowing the generators of correlated infrasonic modulation to be placed such that very large areas can be covered for potential transduction. The use of infrasonic frequencies is certainly the best mode here but nothing herein is intended to limit these methods to infrasonic frequencies.

Sometimes infrasonic geolocation will not be available. For example, it might not be possible to deploy infrasonic transmitters around the area of interest, the area of interest might not be known a priori, or the transduction device might not have the required sensitivity or the transduction device might purposely filter out infrasonic frequencies. Many modern recording types of equipment have options to filter out low-frequency “wind noise,” or “urban” features that filter out background low frequencies so that the desired sounds are not overwhelmed in the recording. These lower frequencies include infrasonics and are present and less naturally attenuated in urban environments, which is also what makes them most useful in the instant method. In these cases naturally occurring or other acoustic signals might be used, infrasonic, audible, and/or ultrasonic. When forced to use these non-cooperative signals one has to take what is available, in any of the aforementioned, frequency ranges. Thunder and artillery might contain all three while an earth tremor might only contain infrasonic frequencies. If the problem is only that the transduction equipment does not have the required sensitivity at the infrasonic frequencies one could deploy cooperative emitters in the audible or ultrasonic ranges. In most environments the propagation and attenuation of higher frequencies make their use less than optimal so audible signals might be required. The use of audible signals carries its own problems. While transmitting infrasonic or ultrasonic signals can be stealthy by nature, audible signals are just that audible. This still leaves several options in the audible range. There are many audible signals adaptable to the instant geolocation method these either natural or manmade could be used. One could create audible but potentially innocuous sounds like a train whistle or helicopter by using an actual train whistle or running or flying a helicopter or one could produce sounds, potentially time encoded, electronically that simply sound like some innocuous local indigenous sound. Another solution available when the transducer sensitivity is very high is to generate audible signals below the amplitude threshold of human hearing or notice.

In very much non-preferred embodiments these acoustic attenuations, especially in non-infrasonic ranges, could be used for a very crude geolocation of the target. The ability of the transducer to even “hear” the signal tells us the transducer is within some crude range of “hearability” from the acoustic transmitter defined by the transmitter acoustic power, frequency, propagation characteristics for that frequency, and sensitivity of the transducer at that frequency. Alternatively, one acoustic transmitter could transmit two acoustic signals of known power and different frequencies. The range of a transducer transducing these tow signals from the transmitter could then be crudely determined by the transduced amplitude ratio between the two signals if the two powers are known, the frequency depended propagation characteristics are known for the two signals, and the transducer sensitivity at the two frequencies were also known.

Once multiple cooperative acoustic infrasonic transmitters are deployed at known locations around an area of interest the area believe to contain the terrorist, for example, transmit time correlated individual infrasonic signals, and the infrasonic signals are retrieved from a terrorist or kidnappers video recording it is a simple matter to determine the location at which the tape was recorded. In the simplest example the transmitters continually transmit a mutually time synchronized code. As long as a modulation scheme is chosen where each of the particular transmitters can be individually identified and the time delay of the time synchronization between pairs such transmitters can be determined, either immediately, in the case of true transmitter synchronization, or after the fact, in the case of a determined synchronization, the location of the recording can be determined by using the time difference between any two transmitters to calculate a line-of-position based on the relative time delay in receiving the two transmitted signals. In the very simple case three transmitters are used and two transmitter pair time delays are measured producing two lines-of-position which cross at the location at which the recording was made. In the art this is known as TDOA/TDOA geolocation.

This time difference can be the difference of an encoded absolute time signal or simply the difference the reception time between two time synchronized transmitters. If the transmitters are not well synchronized or there are un-calibrated propagation delays, these errors may be removed during processing by using receivers of known benchmarked location and comparing that benchmark location to the calculated geolocation to calibrate out the error.

All of these passive receiving geolocation techniques are well known in the art and, in fact, are simple descriptions of the Global Positioning Systems, the LORAN-C System, and Differential GPG (DGPS) systems, all using radio signals vice the infrasonic audio used here.

The audio TDOA/TDOA techniques here are completely analogous to the RF techniques mentioned above. In making the geolocation calculations the speed of sound is used rather that the speed of light, the RF transmitters are replaced by large infrasound speaker systems or other infrasound generators, and the receiver is replaced by a portable VTR built-in microphone.

The present invention is probably more like the LORAN navigation system of old. A pair of synchronized transmitters of known location were chosen. The transmitters transmitted similar signals and the operator simply displayed both on a two trace small screen oscilloscope and then delayed one until it was properly time synced to the other—the time delay identified a particular line-of-position on the earth which was shown on a map. After one or more additional lines-of-position were determined, the location was known. The signal delay measured, because of the extremely long wavelengths used, was often only a phase delay, which was easily matched on a two trace oscilloscope.

In the GPS system the individual satellites all provide an absolute time and a means for deriving the location of the individual satellites at that time using transmitted ephemeris. We need not concern ourselves here with the ephemeris calculations but need to know that the time difference between the two signals provides a line-of-position.

To be precise the time difference solution between to synchronized transmitter is a conic surface and the geolocation solution in 3D when using two pairs of transmitters is the intersection between the two conic surfaces which yields a conic shape. If we allow that the geolocation is known to be on the surface of the earth then the intersection of the conic surface with the surface of the earth is the line-of-position and the intersection of the conic shape with the surface of the earth is the geolocation usually with no ambiguity.

In unusual cases where the acoustic transmitters have significant motion, such as jet aircraft noise or artillery shell wake and the transduction device is stationary audio Doppler techniques could be used to determine the geolocation of the transduction device. These are well known in the art as Frequency Difference of Arrival (FDOA).

The aforementioned features, objects, and advantages of this method over the prior art will become apparent to those skilled in the art from the following detailed description and accompanying drawings.

### BRIEF DESCRIPTION OF THE DRAWINGS

My invention can best be understood when reading the following specification with reference to the accompanying drawings, which are incorporated in and form a part of the specification, illustrate alternate embodiments of the present invention, and together with the description, serve to explain the principles of the invention. In the drawings:

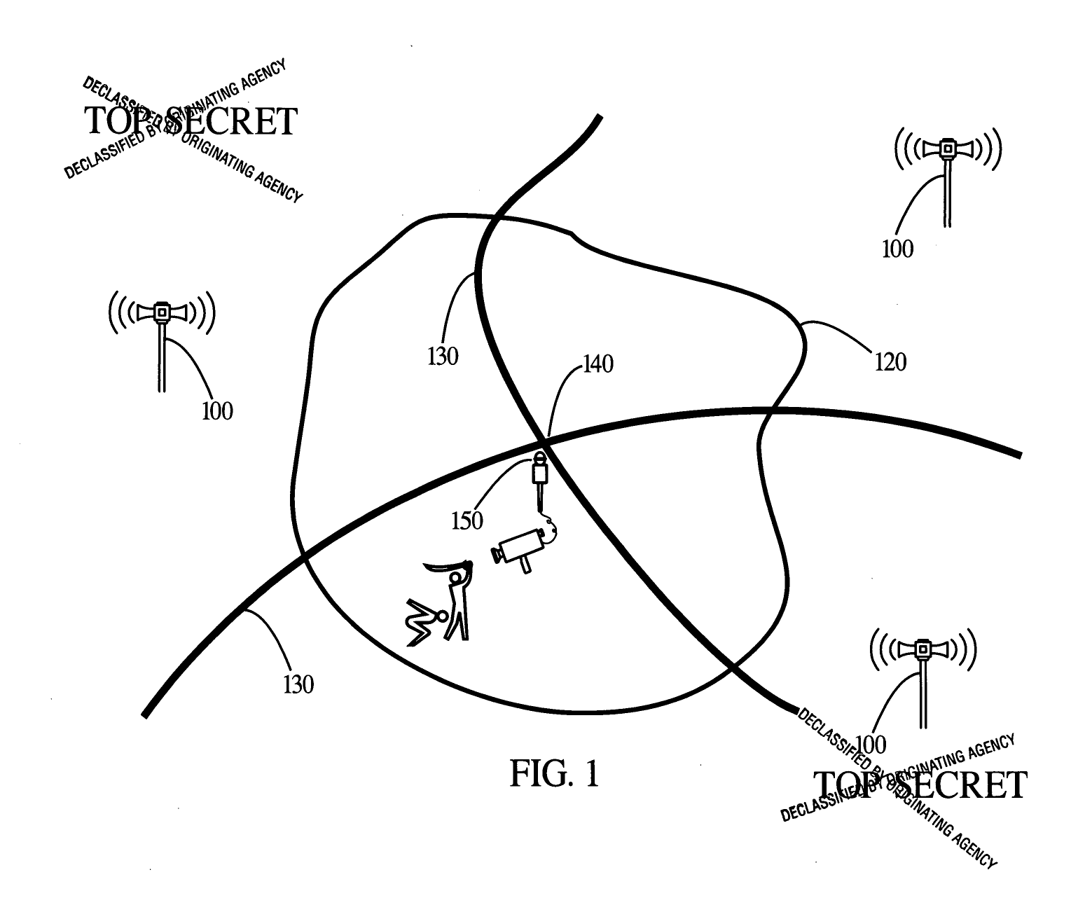

i) FIG. 1 is a drawing showing a typical arrangement of infrasonic transmitters to a target transducer device;

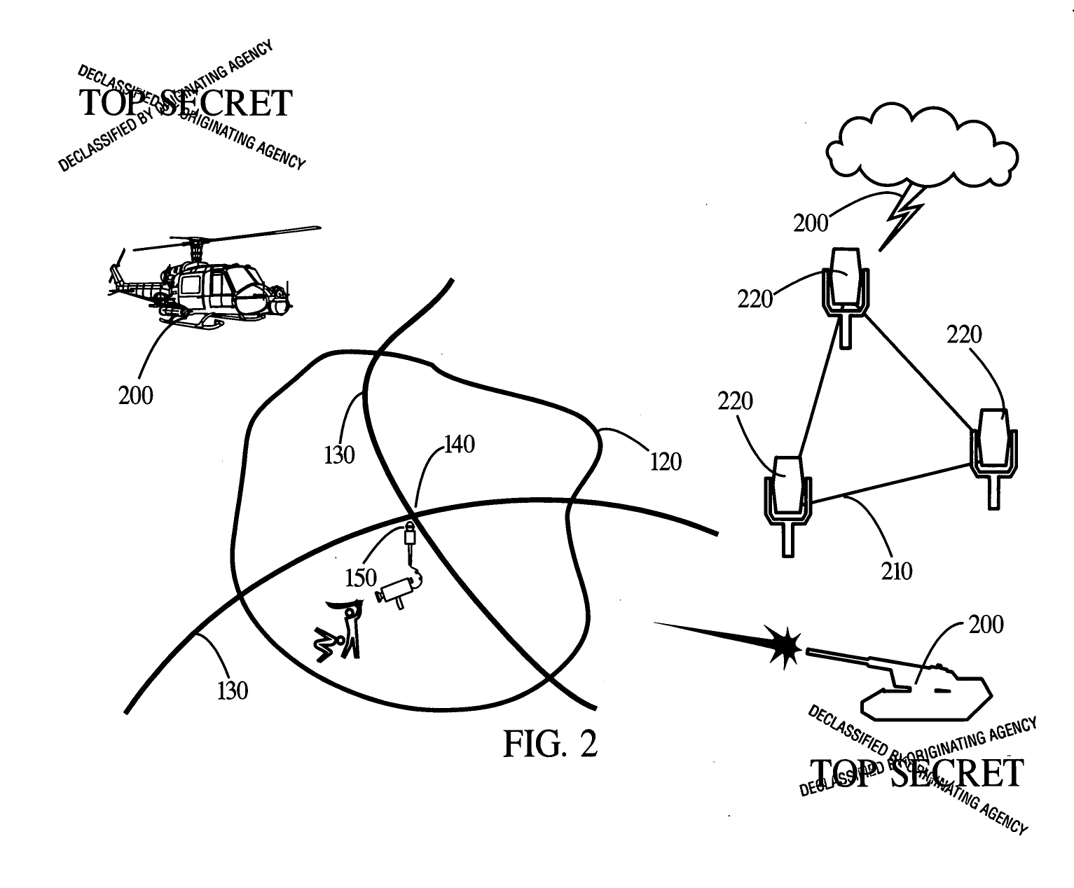

ii) FIG. 2 is a drawing showing the layout of another embodiment where cooperative acoustic transmitters or other cooperative signal sources are not available and the geolocation method must rely on non-cooperative acoustic sources which are geolocated as an intermediate step to the target transducer device geolocation;

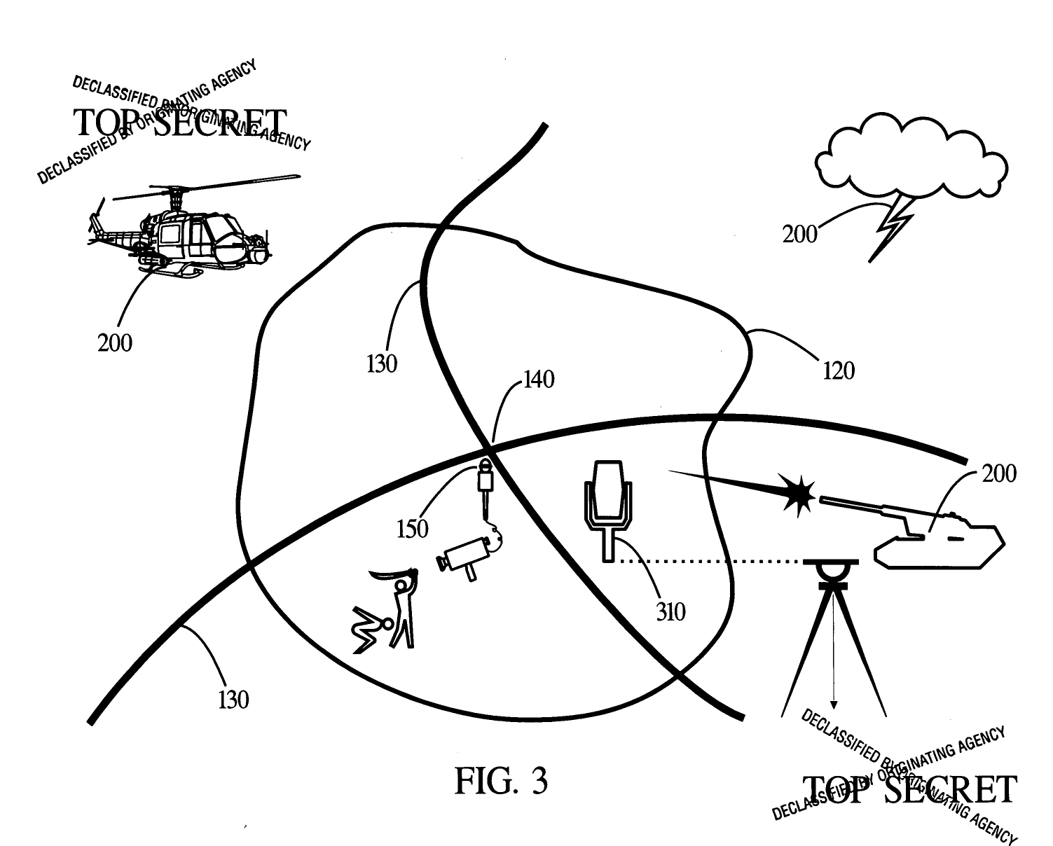

iii) FIG. 3 is a drawing showing the layout of still another embodiment where cooperative acoustic transmitters or other cooperative signal sources are not available and the geolocation method must rely on non-cooperative acoustic sources and the location of the target transducer device is determined by an error vector generated at a benchmark acoustic receiver; and

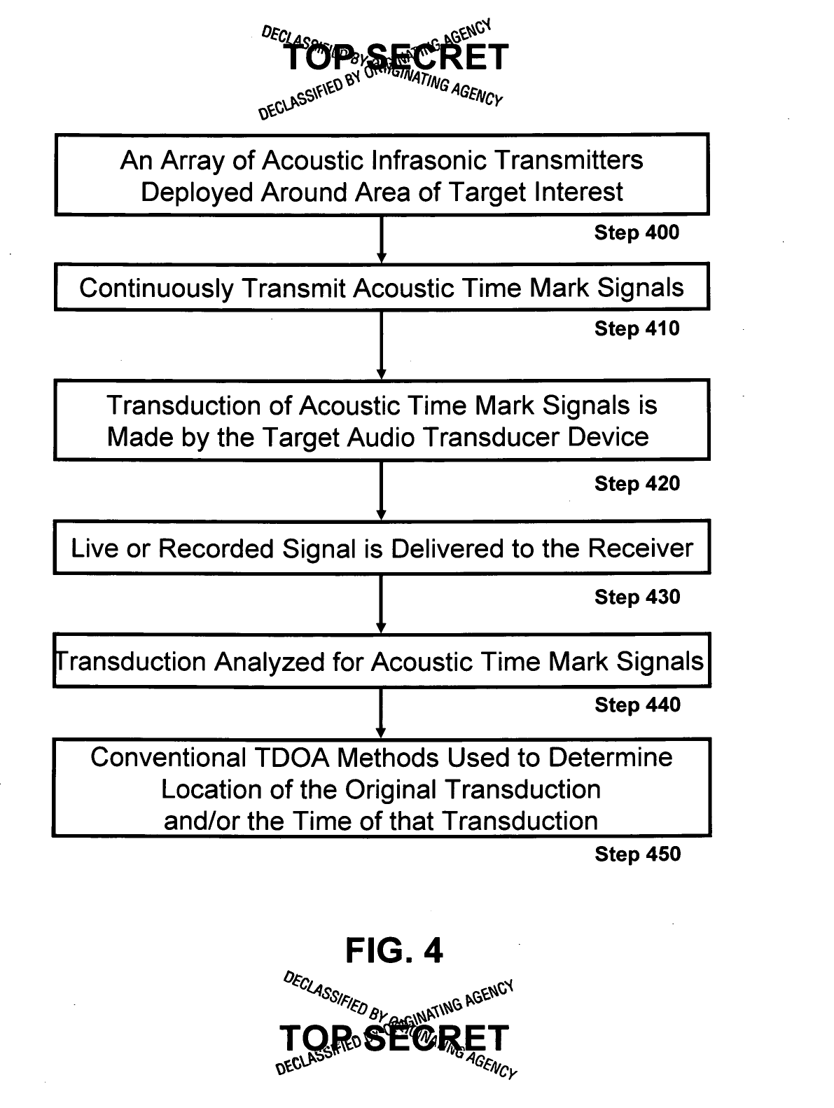

iv) FIG. 4 is a flow chart showing the steps used to geolocate a target transducer device using the instant method.

### DETAILED DESCRIPTION OF THE PREFERRED EMBODIMENTS

In the preferred embodiment, shown in FIG. 1, acoustic infrasonic transmitters 100 are pre-deployed around an area of target interest 120 so as to provide coverage and good spatial resolution to the area of target interest 120. In the preferred case this might consist of three infrasonic transmitters 100 arranged such that the lines-of-position 130 generated between any two of them, using TDOA techniques, form orthogonal lines-of-position 130 in the area of target interest 120. In the preferred embodiment the infrasonic transmitters 100 each transmit a time correlated code-division multiple access (CDMA) modulation code in the infrasonic range such that each acoustic infrasonic transmitter transmits its own time-correlated CDMA modulation in the infrasonic range. The acoustic infrasonic transmitters may all transmit in the same frequency band or may use alternate infrasonic frequency bands, as long as the target location 140 audio transducer device 150, typically a handheld video tape recorder (VTR) microphone, has sufficient response and sensitivity across the bands to capture, or record, in the case of a recorder, the infrasonic modulations with enough fidelity to determine TDOAs between sets of acoustic infrasonic transmitter 100 transmissions and hence lines-of-position 130 between such pairs so that a geolocation can be calculated based on the intersections of the lines-of-position 130.

TDOA geolocation techniques on acoustic signals can work against any acoustic signal that provides for an unambiguous measurement of the time of arrival of that signal, hereinafter an acoustic time mark. In a preferred embodiment this acoustic time mark is part of a signal generated by cooperative acoustic infrasonic transmitters 100 but may also be an uncooperative sound or a sound produced by nature, such as unrelated cannon or artillery fire, jet or train traffic, or seismic or convective weather events. In a preferred embodiment infrasonic acoustic time marks are employed to maintain the covert nature of the geolocation but when non-cooperative sounds are used, this covert geolocation may be protected by the seemingly innocuous nature of the sounds used.

In the preferred embodiment and method the acoustic infrasonic transmitters 100 produce acoustic time marks using a CDMA modulation but many other modulations would provide sufficient acoustic time marks for TDOA calculations. Examples of these include but are not limited to TDMA, PCM, FM, and others. Often a pseudo-random code or actual cryptologically produced code might be used to modulate the transmission using any one of the various available modulation schemes. Those ordinarily skilled in the art will recognize that the code length or modulation scheme repetition period must be such that an unambiguous acoustic time mark will be available over the entire area of target interest 120 and that various combinations of transmitter power and modulation processing gain will be chosen based on the available power, attenuation characteristics and size of the area of target interest 120, as well as the potential transduction device characteristics and compression schemes used and the length of expected transduction. The frequency and modulation of the acoustic infrasonic transmitters 100 should be chosen so as to provide a sufficient acoustic time mark after the audio transducer device 150 uses any indigenous compression algorithm. Often this drives the choice of frequency for these generated signals to a band that is very close to the intended audible band of the device. Additionally, the modulation can be chosen to closely approximate the sounds intended for transduction, typically the human voice.

In a preferred method an array of acoustic infrasonic transmitters 100 are deployed around an area of target interest 120, Step 400, see FIG. 4, and continuously transmit acoustic time mark signals, step 410. Eventually a transduction of these acoustic time mark signals is made by the target audio transducer device 150, step 420, and the resultant live or recorded signal is delivered to the receiver, step 430. In the case of many terrorist recordings the transduction is a handheld VTR recording of some political speech or event and the recording of that event is made available thought videotapes delivered to local media. The transduction is analyzed for acoustic time mark signals, step 440, which, if found, are then used as the input for conventional TDOA methods to determine the location of the original transduction and/or the time of that transduction, step 450 by the target audio transducer device 150 at the target 140.

In other methods the transduction of the acoustic time mark signals can be to an audio recording only or through various real-time methods such as a telephonic real-time communication as long as the target audio transducer device 150, an audio recorder or telephone, as in the instant examples, has enough sensitivity in the infrasonic range used by the acoustic infrasonic transmitters 100.

It is well known that three acoustic infrasonic transmitters 100 are needed to produce an instantaneous two-dimensional geolocation (on the surface of the earth) using TDOA/TDOA methods, but those ordinarily skilled in these arts will notice that greater numbers of acoustic infrasonic transmitters 100 may be employed to provide for better geolocation accuracy or an expanded area of target interest 120. In some methods and embodiments perhaps only two acoustic time mark signals might be available, either through limited acoustic infrasonic transmitter 100 availability or because of signal strength limitations. This could still produce a line-of-position to the target audio transducer device 150. The actual time of transduction can easily be determined based on the acoustic time mark signals used.

In a degenerate embodiment only one acoustic time mark may be recoverable, again either through unavailability of acoustic infrasonic transmitters 100 or because of signal strength limitations. The single acoustic time mark, while not amenable to TDOA methods of geolocation determination still provides a gross geolocation limited to the area around the single transmitter that would have sufficient signal strength to produce a recognizable transduction. Distance estimates from the transmitter could be made based on the recorded signal strength.

In a unique embodiment an acoustic infrasonic transmitter 100 could produce signals at two frequencies, each having its own attenuation characteristics. A crude range from the acoustic infrasonic transmitter 100 could then be determined by the ratio of transducer signals compared to the ratio of transmitted signals. Clearly the sensitivity of the equipment at both frequencies would need to be factored into this equation.

In other embodiments the acoustic infrasonic transmitters 100 could produce ultrasonic or even audible signals. Generally the useful range of ultrasonic signals will be much less than when using infrasonics and the covert nature of the system in not tipping off the target 140 can be lost with audible signals. However, there are classes of audible signals that maintain a covert nature, such a short duration signals, rapidly varying frequency signals (e.g. pink noise), etc.

Short duration signals are characterized as signals that while in the frequency response range of the human ear, can not be heard because of limitations in the auditory perception capabilities of humans.

Other cooperative transmissions that might be used in some embodiments and methods include audible signals that mimic natural or other non-natural innocuous sounds as a way of maintaining the covert nature of the system. These include artificially generated wind noises, or routine civil and urban sounds such as transportation sounds, factory equipment, or signaling devices.

As shown in FIG. 2, in another preferred method and embodiment, cooperative acoustic infrasonic transmitters 100 or other cooperative signal sources are not available. In these cases geolocation must rely solely on non-cooperative transmitters 200, such as the unrelated cannon or artillery fire, jet or train traffic, or seismic or convective weather events mentioned above. Some of these non-cooperative transmitters 200 might actually be under control but not time correlated or coordinated. For example artillery fire or helicopter noise could be insured by fire control or flight orders so that there is always some sound on which to geolocate but as these sounds do not produce coordinated acoustic time marks they will be covered and characterized as non-cooperative transmitters 200.

Because the time of the sound event from non-cooperative transmitters is not controlled or known the TDOA geolocation of the transduction of theses sounds can not be directly calculated. However, if a cooperative transduction array 210 is present near the area of target interest 120 the geolocation of the target 140 audio transducer device 150 can be determined. This can be done using several techniques. If many individual intercept points 220 are available in a cooperative transduction array 210 the actual time of the non-cooperative sound event can be calculated using TDOA methods from the non-cooperative transmitter 200 to the several points in the cooperative transduction array 210. The time and location of the sound event are then known and the sound event then becomes, if effect, a coordinated acoustic time mark from a “cooperative” acoustic infrasonic transmitter 100. If this can be accomplished for multiple non-cooperative transmitters 200 then normal TDOA/TDOA geolocation of the target 140 can proceed using conventional, known TDOA/TDOA methods.

A simpler, limited, and less accurate method uses a cooperative benchmark transducer 310, see FIG. 3, of a single location near the area of target interest 120. This can be thought of as a cooperative transduction array 210 with only one member (individual intercept point 220). Here the geolocation is performed using TDOA on multiple non-cooperative transmitter 200 signals with the location of the acoustic sources set to some arbitrary guessed location and the derived TDOA location is compared to the known location of the benchmark transducer. The difference between these locations is an error vector which can then be used to correct the calculated location of the target 140 transducer device 150 using the same non-cooperative transmitter 200 signals as long as the same arbitrary guessed location of the acoustic sources is used and the same temporal point of the acoustic sources are used in the TDOA calculation.

Similar techniques can be used if the non-cooperative transmitters 200 are truly uncontrollably non-cooperative natural sounds.

Although various preferred embodiments of the present invention have been described herein in detail to provide for complete and clear disclosure, it will be appreciated by those skilled in the art, that variations may be made thereto without departing from the spirit of the invention or the scope of the appended claims.

What is claimed is:

1. An acoustic propagation method, comprising the steps of:
i) Deploying an array of acoustic transmitters within an acoustic propagation distance of at least one target transducer;
ii) Thereafter transmitting individual time encoded signals from each of said acoustic transmitters;
iii) Waiting for a plurality of said individual time encoded signals to be simultaneously transduced by one of said target transducers;
iv) Thereafter obtaining the transduction of said plurality of said individual time encoded signals; and
v) Thereafter calculating the geospatial position of one of said target transducers that simultaneously transduced a plurality of said individual time encoded signals.

2. The acoustic propagation method of claim 1, wherein only two individual time encoded signals are simultaneously transduced and wherein said calculating produces a line of position.

3. The acoustic propagation method of claim 1, wherein said individual time encoded signals are transmitted at infrasonic frequencies.

4. The acoustic propagation method of claim 1, wherein said individual time encoded signals are transmitted at audible frequencies.

5. The acoustic propagation method of claim 1, wherein said individual time encoded signals are transmitted at ultrasonic frequencies.

6. The acoustic propagation method of claim 4, wherein said audible signals mimic an innocuous sound.

7. The acoustic propagation method of claim 4, wherein said audible signals are imperceptible.

8. The acoustic propagation method of claim 1, wherein said individual time encoded signals are CDMA modulated.

9. The acoustic propagation method of claim 1, wherein said individual time encoded signals are pseudo-randomly modulated.

10. The acoustic propagation method of claim 1, wherein said individual time encoded signals are crypto-code modulated.

11. The acoustic propagation method of claim 1, wherein said calculating the geospatial position of one of said target transducers that simultaneously transduced a plurality of said individual time encoded signals uses TDOA methods.

12. The acoustic propagation method of claim 1, wherein said transmitters in said array of acoustic transmitters have motion relative to one of said target transducers and said calculating the geospatial position of one of said target transducers that simultaneously transduced a plurality of said individual time encoded signals uses FDOA methods.

13. The acoustic propagation method of claim 1, wherein the time of transduction is also calculated from said plurality of said individual time encoded signals.

14. The acoustic propagation method of claim 1, wherein the step of deploying an array of acoustic transmitters within acoustic propagation distance of at least one target transducer includes the step of determining the location of at least one non-cooperative acoustic transmitter and the step of thereafter transmitting individual time encoded signals from each of said acoustic transmitters includes assigning an individual time code to an identifiable portion of said individual time encoded signal.

15. The acoustic propagation method of claim 14 wherein the step of determining the location of at least one non-cooperative acoustic transmitter comprises the steps of:
i) Deploying an array of individual intercept points;
ii) Intercepting an identifiable portion of said individual time encoded signals; and
iii) Calculating the geolocation of the non-cooperative acoustic transmitter by using TDOA between some combination of cooperative and non-cooperative acoustic signals.

16. The acoustic propagation method of claim 14 wherein the step of determining the location of at least one non-cooperative acoustic transmitter comprises the steps of:
i) Deploying a single benchmark transducer of known location;
ii) Intercepting an identifiable portion of said individual time encoded signals from at least three of said non-cooperative acoustic transmitters;
iii) Assigning an arbitrary guessed location to said non-cooperative acoustic transmitters;
iv) Calculating the geolocation of said single benchmark transducer of known location using TDOA techniques on the identifiable portion of said individual time encoded signals with the non-cooperative acoustic transmitters of said individual time encoded signals set to said arbitrary guessed locations;
v) Comparing said calculated geolocation to said known location and setting a benchmark error vector set to the difference between said calculated geolocation and said known location;
vi) Waiting for a plurality of said individual time codes assigned to an identifiable portion of said individual time encoded signal to be simultaneously transduced by one of said target transducers;
vii) Thereafter obtaining the transduction of said plurality of said individual time encoded signals; and
viii) Thereafter calculating the geospatial position of one of said target transducers that simultaneously transduced a plurality of said individual time encoded signals; and
ix) Using said benchmark error vector to correct said geospatial position.

17. An acoustic propagation method, comprising the steps of:
i) Deploying a single acoustic transmitter within an acoustic propagation distance of at least one target transducer;
ii) Thereafter transmitting an acoustic signal from said acoustic transmitter of known power;
iii) Waiting for said acoustic signal to be transduced by one of said target transducers;
iv) Thereafter obtaining the transduction of acoustic signal; and
v) Thereafter determining the range of the target transducer from said acoustic transmitter by comparing the power of the transduced acoustic signal to that of the transmitted acoustic signal, taking into account the propagation characteristics of the acoustic signal and the sensitivity of the target transducer.

18. An acoustic propagation method, comprising the steps of:
i) Deploying a single acoustic transmitter within an acoustic propagation distance of at least one target transducer;
ii) Thereafter transmitting two acoustic signals of differing frequencies and known power from said acoustic transmitter;
iii) Waiting for said acoustic signals to be transduced by one of said target transducers;
iv) Thereafter obtaining the transduction of acoustic signals;
v) Determining the signal attenuation for each of the two acoustic signals; and
vi) Thereafter determining the range of the target transducer from said acoustic transmitter by comparing the signal attenuation for each of the two acoustic signals to each other knowing the signal propagation characteristics of the acoustic signals as a function of frequency and the sensitivity of the target transducer.
